(19) United States
(12) Patent Application Publication
(10) Pub. No.: US 2025/0200361 A1
(43) Pub. Date: Jun. 19, 2025

(54) SELECTIVE LEARNING OF INFORMATION FOR THE GENERATION OF PERSONALIZED RESPONSES BY A GENERATIVE RESPONSE ENGINE

(71) Applicant: OpenAI OpCo, LLC., San Francisco, CA (US)

(72) Inventors: Prasad Chakka, Palo Alto, CA (US); Dave Cummings, San Francisco, CA (US); Noah Deutsch, San Francisco, CA (US); William Fedus, San Francisco, CA (US); Tarun Gogineni, San Francisco, CA (US); Yuchen He, Redwood City, CA (US); Joanne Jang, San Francisco, CA (US); Lien Mamitsuka, Los Altos, CA (US); Warren Ouyang, Sunnyvale, CA (US); Yilei Qian, Hillsborough, CA (US); John Schulman, San Francisco, CA (US); Javi Soto Bustos, Oakland, CA (US); Anton Tananaev, San Francisco, CA (US); Jonathan Ward, San Francisco, CA (US); Marvin Zhang, San Francisco, CA (US); Benjamin Zweig, San Francisco, CA (US)

(73) Assignee: OpenAI OpCo, LLC., San Francisco, CA (US)

(21) Appl. No.: 18/732,157

(22) Filed: Jun. 3, 2024

Related U.S. Application Data
(60) Provisional application No. 63/609,558, filed on Dec. 13, 2023.

(51) Int. Cl. G06N 3/08

(52) U.S. Cl. CPC G06N 3/08

(57) ABSTRACT

The present technology provides for the learning of information relevant to a user account by a generative response engine and accessing this information when preparing personalized responses to prompts provided by the user account. A further aspect of the present technology is that the user account does not need to explicitly tell the generative response engine to remember a particular information. Instead, the present technology is configured such that the generative response engine can learn such facts, preferences, or contexts from conversational prompts provided to the chatbot without providing explicit instructions to remember the data. A further aspect of the present technology is that the user account can request that the generative response engine forget some learned facts too.

### CROSS-REFERENCE TO RELATED APPLICATIONS

This application claims the benefit of priority to U.S. provisional application No. 63/609,558, filed on Dec. 13, 2023, entitled SELECTIVE LEARNING OF INFORMATION FOR THE GENERATION OF PERSONALIZED RESPONSES BY A GENERATIVE RESPONSE ENGINE, which is expressly incorporated by reference herein in its entirety.

### BACKGROUND

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. Generative response engines can sift through vast amounts of text data, extract context, and provide coherent responses to a wide array of queries. However, despite their remarkable linguistic prowess, these generative response engines operate on a foundation of publicly available information and do not possess personal information about individual users. While they can engage in informative and context-rich conversations, they rely solely on the data they have been trained on and lack access to personal details or experiences specific to each user.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1A illustrates an example of a frustrating instance of an interaction with a generative response engine.

FIG. 1B illustrates an example of an improved user experience when the generative response engine is able to learn facts, preferences, and context from a user account in accordance with some aspects of the present technology.

FIG. 2 is a block diagram illustrating an exemplary machine learning platform for implementing various aspects of this disclosure in accordance with some aspects of the present technology.

FIG. 3 illustrates an example process for the selective learning of information for the generation of personalized responses by a generative response engine in accordance with some aspects of the present technology.

FIG. 4 illustrates an example personalization notepad in accordance with some aspects of the present technology.

FIG. 5 illustrates an example process for deleting a learned information in accordance with some aspects of the present technology.

FIG. 6 illustrates example interactions with the generative response engine to request that information be deleted in accordance with some aspects of the present technology.

FIG. 7 illustrates an example memory management interface in accordance with some aspects of the present technology.

FIG. 8A and FIG. 8B illustrates the presence of an information in a personalization notepad that can be deleted in accordance with some aspects of the present technology.

FIG. 9 illustrates an example process for performing an asynchronous consolidation process on the personalization notepad in accordance with some aspects of the present technology.

FIG. 10 illustrates an example process for creating a deep memory in accordance with some aspects of the present technology.

FIG. 11 illustrates an example settings user interface in accordance with some aspects of the present technology.

FIG. 12 shows an example of a system for implementing certain aspects of the present technology.

### DETAILED DESCRIPTION

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. However, despite their remarkable linguistic prowess, these generative response engines operate on a foundation of publicly available information and do not possess personal information about individual users.

Many generative response engines provide a conversational user interface powered by a chatbot whereby the user account interacts with the generative response engine through natural language conversation with the chatbot. Such a user interface provides an intuitive format to provide prompts or instructions to the generative response engine. In fact, the conversational user interface powered by the chatbot can be so effective that users can feel as if they are interacting with a person. Some user accounts find the generative response engine effective enough that they utilize the conversational user interface powered by the chatbot as they would an assistant.

However, one area in which these generative response engines could be improved is their ability to learn some personal information about the user of the user account. Some users can be surprised or even frustrated that they need to repeat certain personal facts or preferences to the chatbot across multiple threads. In some ways, this frustration is borne out of the otherwise impressive performance of the chatbot to a level where users of user accounts feel as if they are conversing with a human assistant. Another potential cause of this frustration can have its foundation in the fact that some of these generative response engines store a history of prompts and responses in past topic-centric threads. It can be frustrating to some users to interact with such an effective chatbot that appears to have the knowledge of the entire Internet at the ready, but since the chatbot does not use the contents of the past topic-centric threads for creating responses to prompts in a different topic-centric thread, the chatbot might not know a fact that it was told in a prior prompt.

The present technology addresses this problem by allowing the generative response engine to learn information associated with a user account and to access this information when preparing responses to prompts provided by the user account. In some embodiments, the information can include facts, preferences, and context detected in prompts.

However, in some embodiments, the generative response engine is configured or trained to be selective in which information it learns. The reasons for being selective in the information in which the generative response engine learns are both to provide more efficient performance and to provide a better user experience. More specifically, if the generative response engine were to learn an unlimited amount of data, the learned data could become very large and would degrade the response times of the generative response engine. In addition, some users are wary of generative response engines and do not want a user experience that feels like the user account is interacting with some being or technology that knows everything about them. While it presents a little bit of a paradox that users want the generative response engine to remember some information that they have been told before, they might not want the generative response engine to remember everything. After all, most human assistants don't remember everything either. Further, the present technology is configured such that the data that the generative response engine has learned is easily reviewable, which benefits from maintaining a limited amount of data.

A further aspect of the present technology is that the user account does not need to explicitly tell the generative response engine to remember particular information. Instead, the present technology is configured such that the generative response engine should learn such facts, preferences, or contexts from conversational prompts provided to the chatbot without providing explicit instructions to remember the data.

A further aspect of the present technology is that the user account can request that the generative response engine forget some learned facts too.

One aspect of the present technology may be the gathering and use of data available from various sources that may include personal information data that uniquely identifies or can be used to contact or locate a specific person. Such personal information data can include demographic data, location-based data, telephone numbers, email addresses, IDs, home addresses, data or records relating to a user's health or level of fitness (e.g., vital signs measurements, medication information, exercise information), date of birth, or any other identifying or personal information.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Further, such collection/sharing should occur after receiving the informed consent of the users.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter.

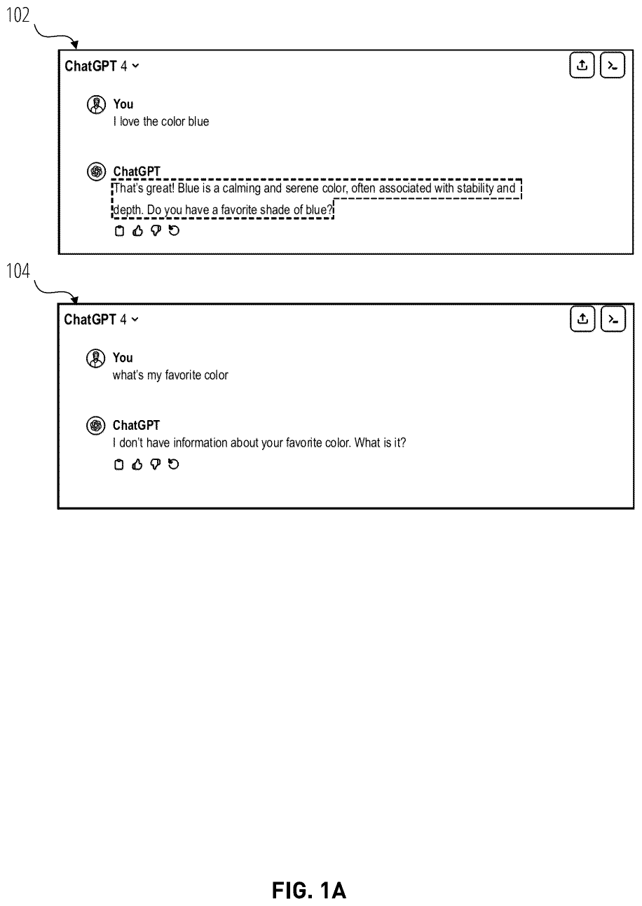

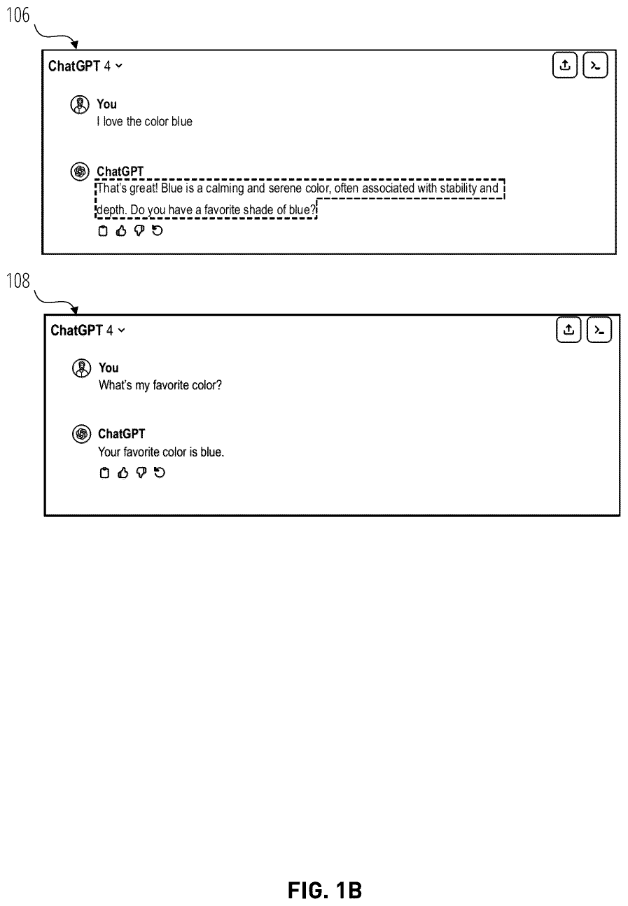

FIG. 1A illustrates an example of a frustrating instance of an interaction with a generative response engine. For example, while a user account interacts with the generative response engine in a first interaction 102, the user associated with the user account can provide a prompt indicating a preference for the color blue. However, when the user account interacts with the generative response engine in a second interaction 104. The user associated with the user account can provide a prompt for which the knowledge of the user's preference for the color blue would be beneficial. Although the user has already had an interaction with the generative response engine that provides the information that the user has a preference for the color blue, the generative response engine does not remember this preference in subsequent interaction sessions.

FIG. 1B illustrates an example of an improved user experience when the generative response engine is able to learn facts, preferences, and context from a user account in accordance with some aspects of the present technology. For example, while a user account interacts with the generative response engine in a first interaction 106, the user associated with the user account can provide a prompt indicating a preference for the color blue. Then when the user account later interacts with the generative response engine in a second interaction 108, the user associated with the user account can provide a prompt for which the knowledge of their preference for the color blue would be beneficial, and the generative response engine can provide a response that utilizes the learned knowledge from the first interaction 106.

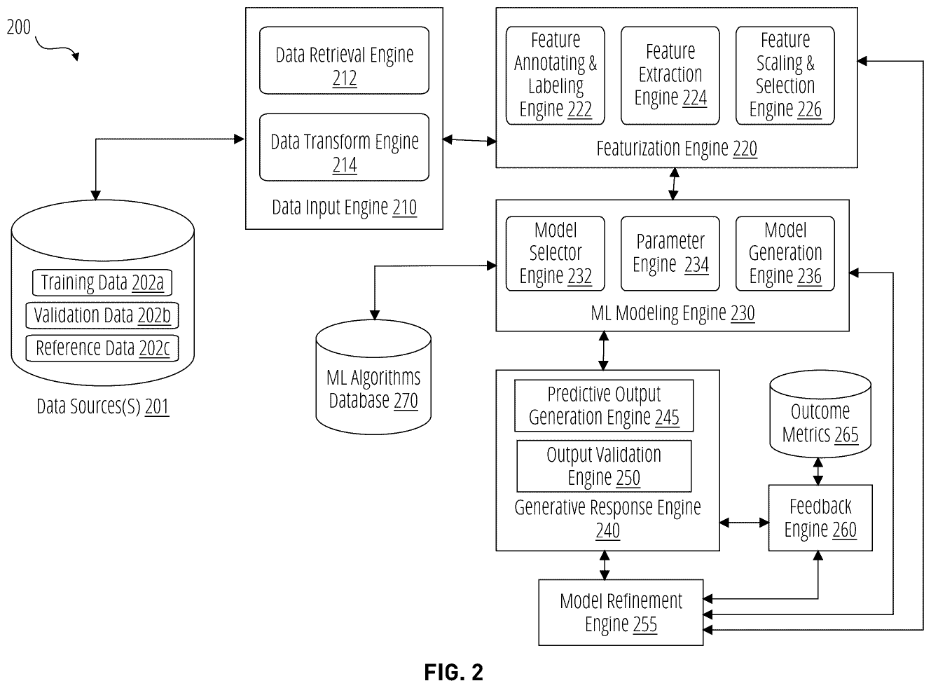

FIG. 2 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 200 may include data input engine 210 that can further include data retrieval engine 212 and data transform engine 214. Data retrieval engine 212 may be configured to access, interpret, request, or receive data, which may be adjusted, reformatted, or changed (e.g., to be interpretable by another engine, such as data input engine 210). For example, data retrieval engine 212 may request data from a remote source using an API. Data input engine 210 may be configured to access, interpret, request, format, re-format, or receive input data from data sources(s) 201. For example, data input engine 210 may be configured to use data transform engine 214 to execute a re-configuration or other change to data, such as a data dimension reduction. In some embodiments, data sources(s) 201 may be associated with a single entity (e.g., organization) or with multiple entities. Data sources(s) 201 may include one or more of training data 202a (e.g., input data to feed a machine learning model as part of one or more training processes), validation data 202b (e.g., data against which at least one processor may compare model output with, such as to determine model output quality), and/or reference data 202c. In some embodiments, data input engine 210 can be implemented using at least one computing device. For example, data from data sources(s) 201 can be obtained through one or more I/O devices and/or network interfaces. Further, the data may be stored (e.g., during execution of one or more operations) in a suitable storage or system memory. Data input engine 210 may also be configured to interact with a data storage, which may be implemented on a computing device that stores data in storage or system memory.

System 200 may include featurization engine 220. Featurization engine 220 may include feature annotating & labeling engine 222 (e.g., configured to annotate or label features from a model or data, which may be extracted by feature extraction engine 224), feature extraction engine 224 (e.g., configured to extract one or more features from a model or data), and/or feature scaling & selection engine 226 Feature scaling & selection engine 226 may be configured to determine, select, limit, constrain, concatenate, or define features (e.g., AI features) for use with AI models.

System 200 may also include machine learning (ML) ML modeling engine 230, which may be configured to execute one or more operations on a machine learning model (e.g., model training, model re-configuration, model validation, model testing), such as those described in the processes described herein. For example, ML modeling engine 230 may execute an operation to train a machine learning model, such as adding, removing, or modifying a model parameter. Training of a machine learning model may be supervised, semi-supervised, or unsupervised. In some embodiments, training of a machine learning model may include multiple epochs, or passes of data (e.g., training data 202a) through a machine learning model process (e.g., a training process). In some embodiments, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed embodiments in any way, a machine learning model may include millions, billions, or even trillions of model parameters. ML modeling engine 230 may include model selector engine 232 (e.g., configured to select a model from among a plurality of models, such as based on input data), parameter engine 234 (e.g., configured to add, remove, and/or change one or more parameters of a model), and/or model generation engine 236 (e.g., configured to generate one or more machine learning models, such as according to model input data, model output data, comparison data, and/or validation data).

In some embodiments, model selector engine 232 may be configured to receive input and/or transmit output to ML algorithms database 270. Similarly, featurization engine 220 can utilize storage or system memory for storing data and can utilize one or more I/O devices or network interfaces for transmitting or receiving data. ML algorithms database 270 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein.

System 200 can further include generative response engine 240 that is made up of a predictive output generation engine 245, output validation engine 250 (e.g., configured to apply validation data to machine learning model output). Predictive output generation engine 245 can be configured to receive inputs that provide some guidance as to a desired output. Predictive output generation engine 245 can analyze the input and identify relevant patterns and associations in the data it has learned to generate a sequence of words that predictive output generation engine 245 predicts is the most likely continuation of the input, aiming to provide a coherent and contextually relevant answer. Predictive output generation engine 245 generates responses by sampling from the probability distribution of possible words and sequences, guided by the patterns observed during its training. In some embodiments, predictive output generation engine 245 can generate multiple possible responses before presenting the final one. Predictive output generation engine 245 can generate multiple responses based on the input, and these responses are variations that predictive output generation engine 245 considers potentially relevant and coherent. Output validation engine 250 can evaluate these generated responses based on certain criteria. These criteria can include relevance to the prompt, coherence, fluency, and sometimes adherence to specific guidelines or rules, depending on the application. Based on this evaluation, output validation engine 250 selects the most appropriate response. This selection is typically the one that scores highest on the set criteria, balancing factors like relevance, informativeness, and coherence.

System 200 can further include feedback engine 260 (e.g., configured to apply feedback from a user and/or machine to a model) and model refinement engine 255 (e.g., configured to update or re-configure a model). In some embodiments, feedback engine 260 may receive input and/or transmit output (e.g., output from a trained, partially trained, or untrained model) to outcome metrics database 265. Outcome metrics database 265 may be configured to store output from one or more models and may also be configured to associate output with one or more models. In some embodiments, outcome metrics database 265, or other device (e.g., model refinement engine 255 or feedback engine 260), may be configured to correlate output, detect trends in output data, and/or infer a change to input or model parameters to cause a particular model output or type of model output. In some embodiments, model refinement engine 255 may receive output from predictive output generation engine 245 or output validation engine 250. In some embodiments, model refinement engine 255 may transmit the received output to featurization engine 220 or ML modeling engine 230 in one or more iterative cycles.

The engines of system 200 may be packaged functional hardware units designed for use with other components or a part of a program that performs a particular function (e.g., of related functions). Any or each of these modules may be implemented using a computing device. In some embodiments, the functionality of system 200 may be split across multiple computing devices to allow for distributed processing of the data, which may improve output speed and reduce computational load on individual devices. In some embodiments, system 200 may use load-balancing to maintain stable resource load (e.g., processing load, memory load, or bandwidth load) across multiple computing devices and to reduce the risk of a computing device or connection becoming overloaded. In these or other embodiments, the different components may communicate over one or more I/O devices and/or network interfaces.

System 200 can be related to different domains or fields of use. Descriptions of embodiments related to specific domains, such as natural language processing or language modeling, is not intended to limit the disclosed embodiments to those specific domains, and embodiments consistent with the present disclosure can apply to any domain that utilizes predictive modeling based on available data.

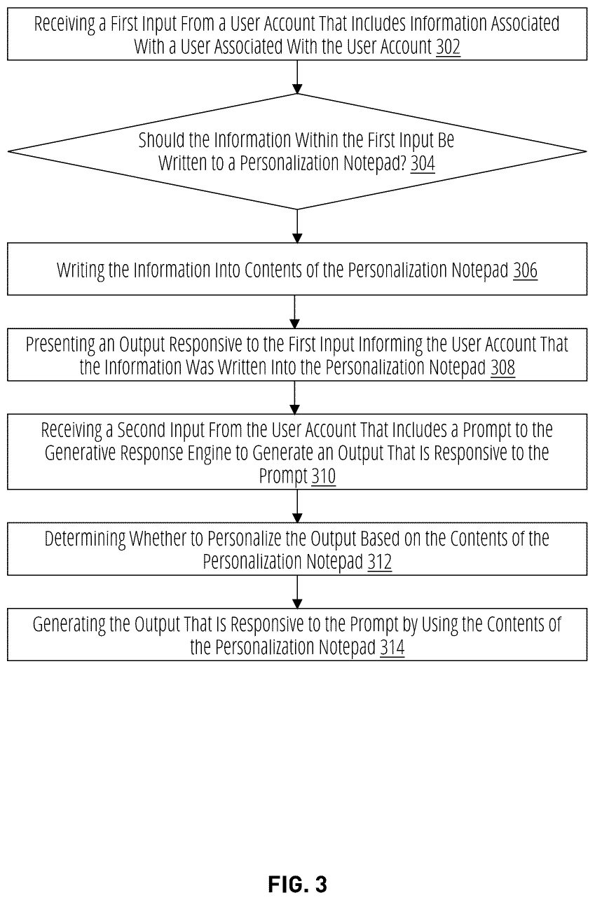

FIG. 3 illustrates an example process for the selective learning of facts for the generation of personalized responses by a generative response engine in accordance with some aspects of the present technology. Although the example process depicts a particular sequence of operations, the sequence may be altered without departing from the scope of the present disclosure. For example, some of the operations depicted may be performed in parallel or in a different sequence that does not materially affect the function of the process. In other examples, different components of an example device or system that implements the process may perform functions at substantially the same time or in a specific sequence.

As introduced above, one area in which generative response engines could be improved is their ability to learn some information about the user of the user account. Some users can be surprised or even frustrated that they need to repeat certain information to the chatbot. In some ways, this frustration is borne out of the otherwise impressive performance of the chatbot to a level where users of user accounts feel as if they are conversing with a human assistant. Another potential cause of this frustration can have its foundation in the fact that some of these generative response engines store a history of prompts and responses in past topic-centric threads. It can be frustrating to some users to interact with such an effective chatbot that appears to have the knowledge of the entire Internet at the ready, but since the chatbot does not use the contents of the past topic-centric threads for creating responses to prompts in a different topic-centric thread, the chatbot might not know a fact that it was told in a prior prompt.

The present technology addresses this problem by allowing the generative response engine to selectively learn facts, preferences, and context associated with a user account and to access this information when preparing responses to prompts provided by the user account.

According to some examples, the method includes receiving, by a generative response engine, a first input from a user account that includes an information associated with the user account including the user of the user account at block 302. For example, the generative response engine 240 illustrated in FIG. 2 may receive a first input from a user account that includes an information associated with the user account.

The first input can be provided by the user to a computing device through a user interface of the computing device. The first input can be a typed prompt, a verbal prompt, or a series of prompts over time, which, when analyzed together, identify the information. The first input can be provided in the form of a natural language prompt or an uploaded image or video. For example, as illustrated in FIG. 1B the prompt can include a statement about a user's preference, such as that they like the color blue.

According to some examples, the method includes determining whether the information within the first input should be written to a personalization notepad at decision block 304. For example, the generative response engine 240 illustrated in FIG. 2 may determine whether the information within the first input should be written to a personalization notepad. As will be described further herein, the personalization notepad is an example of a file or data structure that can store learned information.

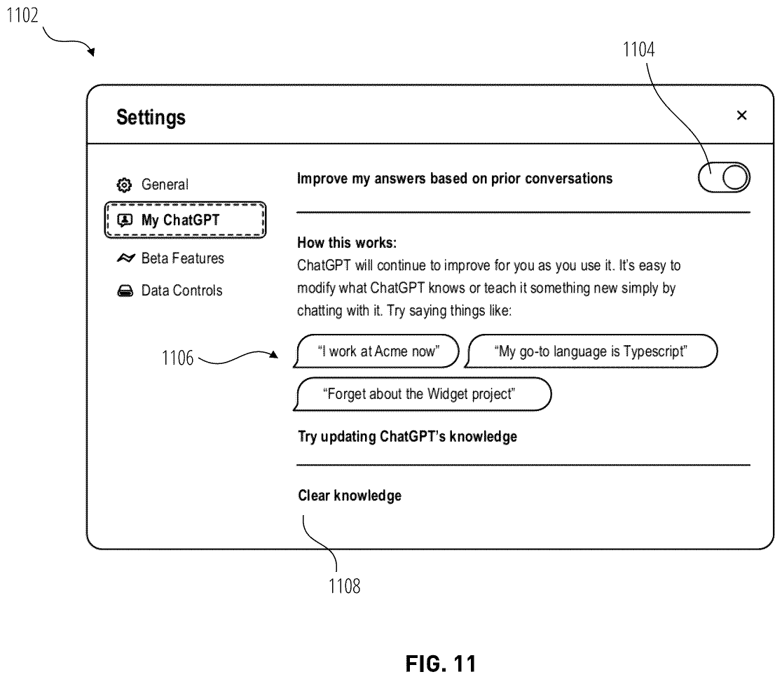

A prerequisite for the generative response engine 240 to determine to learn any potential information can be that the user account expects this behavior from the generative response engine 240. In some embodiments, the user account can expect this behavior by explicitly opting-in to the feature, as illustrated in FIG. 11. Additionally, even if the user account has opted-in to the feature, the feature can be temporarily disabled whenever the user account takes behaviors that indicate that they do not want their conversations with the generative response engine 240 to be saved. For example, past topic-based-threads are generally saved by the generative response engine 240 and are accessible to the user account for later review. However, the user account can choose to have a topic-based-thread not be saved by de-selecting a track topics option. If the track topics option is not enabled, the generative response engine will not save a thread associated with the current topic and will not learn any information from that thread. Even when the user account has opted-into the feature to learn some personal information about the user account, the generative response engine 240 will not learn any information from threads that are not to be saved.

In some embodiments, the generative response engine 240 is trained to both detect possible information and to determine whether the information should be written to a personalization notepad. The training of the generative response engine can utilize a reinforcement learning process, whereby the generative response engine can identify training information, within the training prompt and provide a score to reflect a probability that the training information should be saved. Feedback can be provided to the generative response engine through a reward function. The feedback can be in the form of an external score from a source other than the generative response engine that indicates whether the training information should be saved. For example, the external score can be provided by human labelers. As is common in reinforcement learning, the generative response engine can adjust itself to produce future scoring that is more likely to receive higher external scores.

In some embodiments, instead of or in addition to the reinforcement learning process, the generative response engine can use one or more heuristics to indicate that the information within the first input should be written to the personalization notepad. For example, a first heuristic can identify important personal facts, wherein the important personal facts are not sensitive facts such as health data. A second heuristic can identify contextual facts regarding the user of the user account.

In some embodiments, the generative response engine 240 is configured to learn the information from a user account's regular interactions with the user interface of the generative response engine 240 or through prompts submitted through an application programming interface (API). That is, the user account should not need to explicitly teach the generative response engine 240 information. Just as a person would interact with a human assistant and the human assistant would naturally learn some information about the person they were assisting, so too should the generative response engine.

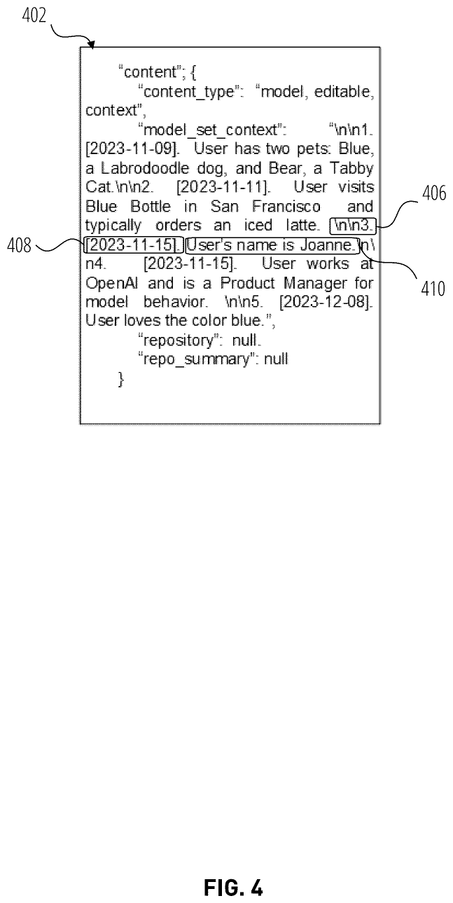

According to some examples, the method includes writing the information that the generative response engine has determined should be saved into the contents of the personalization notepad at block 306. For example, the generative response engine 240 illustrated in FIG. 2 may write the information into the contents of the personalization notepad. In some embodiments, the information is included as a token within the personalization notepad. The token can be a brief snippet of text in a human-readable format. An example of the personalization notepad that includes the notes is illustrated in FIG. 4.

The personalization notepad can be limited to a configured number of notes or a number of tokens. For example, a configured number of notes might be 20, 50, 100, 200, 500, etc. An example of a note might be a concept such as illustrated as note 410 in FIG. 4. For example, a configured number of tokens can be 100, 200, 500, 1,000, 2,000, 4,000, 10,000, or 100,000 tokens. In the context of a large language model, a token refers to the individual processable units, e.g., units of text, such as words, subwords, or characters, or units of pixels of an image, that are used to represent an input sequence. These tokens are the basic building blocks upon which the language model operates, and they can consist of anything from complete words to characters or groups of pixels or individual pixels, depending on the specific model and tokenization scheme used. In essence, tokens are the fundamental elements that the language model processes and manipulates to generate outputs. The personalization notepad is limited in the number of notes or tokens to ensure that the generative response engine 240 can still be responsive and exhibit minimal latency while preparing responses to prompts with the aid of the contents of the personalization notepad.

According to some examples, the method includes presenting an output responsive to the first input informing the user account that the information was written into the personalization notepad at block 308. For example, the generative response engine 240 illustrated in FIG. 2 may present an output responsive to the first input informing the user account that the information was written into the personalization notepad. In some embodiments, the step of explicitly telling the user account that the information was noted might produce an undesirable user experience and can be skipped. After all, a human assistant does not provide confirmation of every fact that they learn either. In some embodiments, this functionality can be configurable by selection of an option associated with the user account.

In some ways, the personalization notepad functions much like an analog notepad might be utilized by a human assistant. As information is learned, it can be written to the notepad. Then, just as a human assistant might refer to the notepad to see if it contains any relevant notes while performing a subsequent task, so too does the generative response engine 240.

According to some examples, the method includes receiving a second input from the user account that includes a prompt to the generative response engine to generate an output that is responsive to the prompt at block 310. For example, the generative response engine 240 illustrated in FIG. 2 may receive a second input from the user account that includes a prompt to generate an output that is responsive to the prompt.

According to some examples, the method includes determining whether to personalize the output based on the contents of the personalization notepad at block 312. For example, the generative response engine 240 illustrated in FIG. 2 may determine whether to personalize the output based on the contents of the personalization notepad.

According to some examples, the method includes generating the output that is responsive to the prompt by using the contents of the personalization notepad at block 314. For example, the generative response engine 240 illustrated in FIG. 2 may generate the output that is responsive to the prompt by using the contents of the personalization notepad.

In practice, the steps described with respect to block 312 and block 314 might be performed together. For example, the generative response engine 240 can have access to, and refer to the contents of the personalization notepad. With access to the contents of the personalization notepad, the generative response engine 240 can generate at least a portion of a first candidate response that includes personalization and generate at least a portion of a second candidate response that does not include personalization. The generative response engine 240 can evaluate and score the first candidate response and second candidate response and select the preferred candidate response based on the scoring.

In some embodiments, it can be easy to determine that the output of the generative response engine was influenced by the contents of the personalization notepad when the output explicitly refers to the contents of the personalization notepad, when the output is arranged to address a preference stored within the contents of the personalization notepad, or when the output is limited based on a preference stored within the contents of the personalization notepad, etc.

While the present description has thus far addressed identifying information from a prompt or prompts in a thread, in some embodiments, the first input can be a series of prompts over time and across different threads, which, when analyzed together, identify the information. Some information might not be identifiable from a single prompt but become apparent from a series of prompts. For example, a first prompt might ask for help responding to a difficult email from their boss. A second prompt might include an indication that the user is having a bad day. Later in the week, a third prompt might also include some indication of misfortune or a downtrodden mood. Taken collectively, the generative response engine could determine that the user is having a bad week and use that to provide words of sympathy or to adjust some responses to be more light-hearted.

In some embodiments, the user account can be associated with a plurality of identities of the generative response engine. A user account might want to be associated with a plurality of identities to keep some types of prompts and responses separate from other types of prompts and responses. Perhaps a user account might use one identity for personal content and another identity for work content. The different identities can be associated with a respective personalization notepad, whereby the different identities can be associated with different sets of information.

FIG. 4 illustrates an example personalization notepad in accordance with some aspects of the present technology. As illustrated in FIG. 4, the personalization notepad 402 can include a plurality of notes that are made up of a note number 406, a date 408, and the note 410 containing the information. For example, note number 3 was created on Nov. 15, 2023, and the fact is the name of the user.

The personalization notepad is in a user-readable format. In some embodiments, the personalization notepad 402 can be surfaced for inspection by the user account.

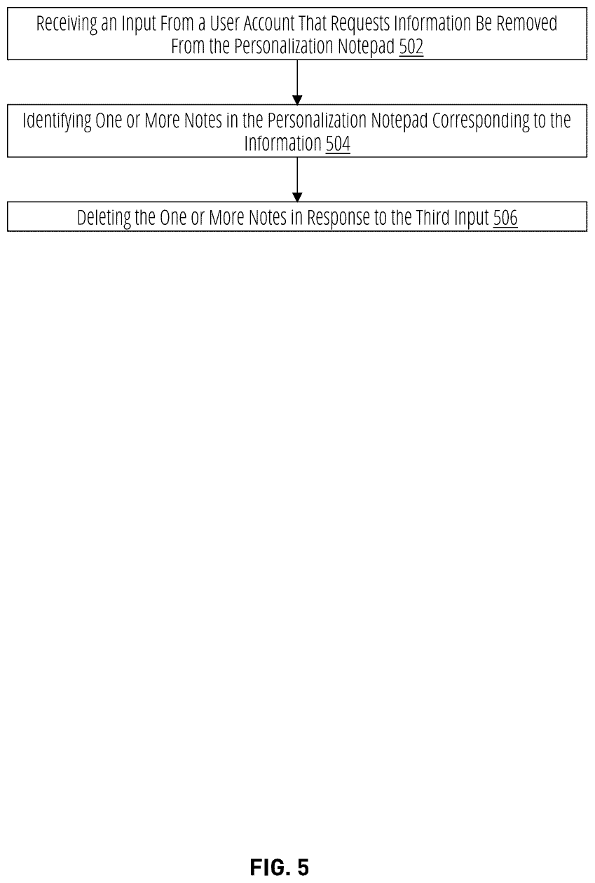

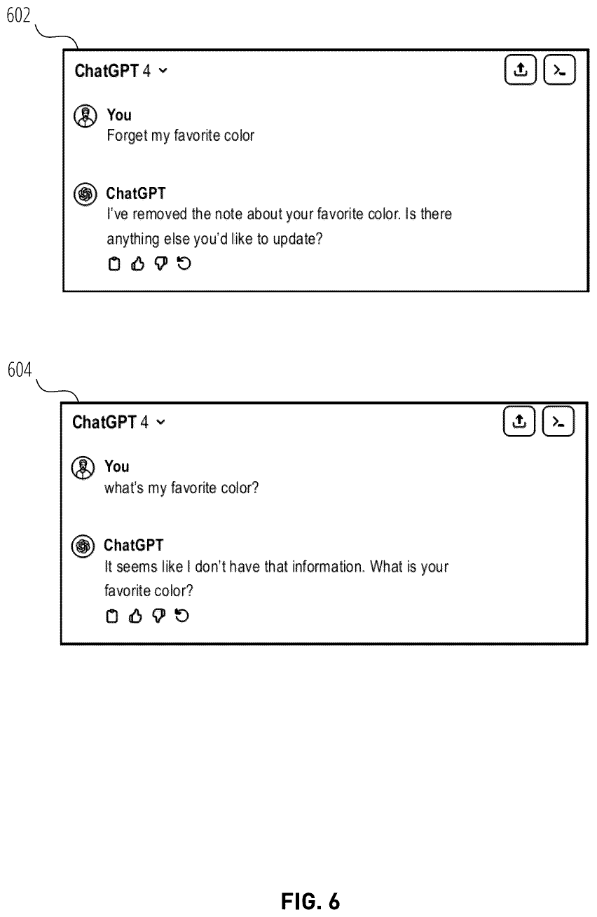

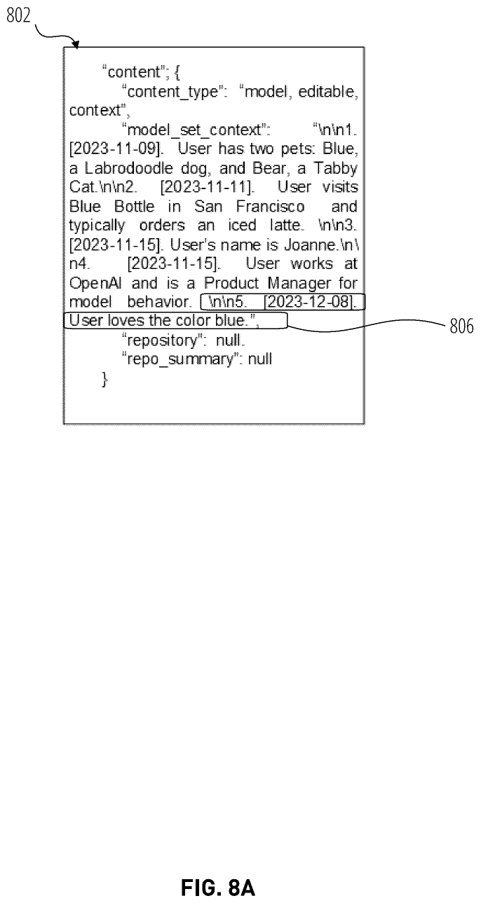

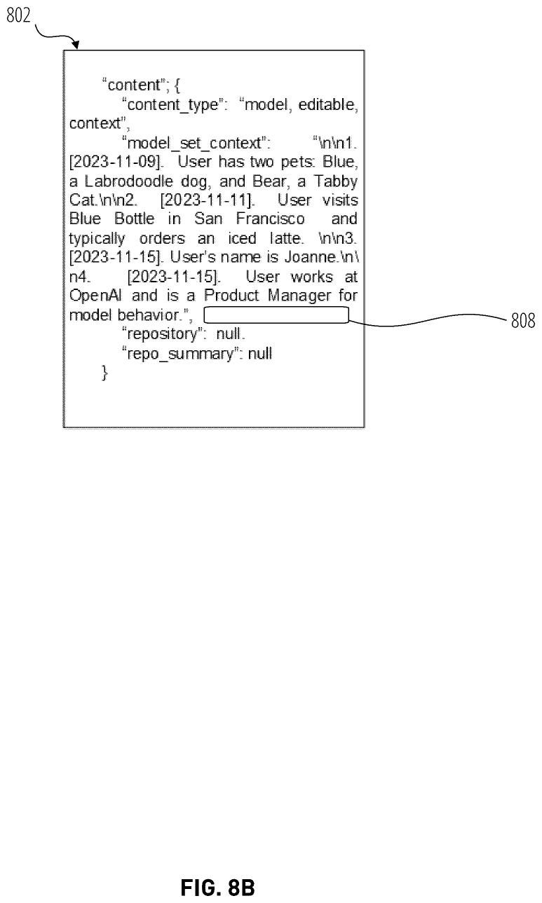

As addressed in FIG. 5, FIG. 6, FIG. 8A, and FIG. 8B there are occasions when the user account might wish to delete one or more notes.

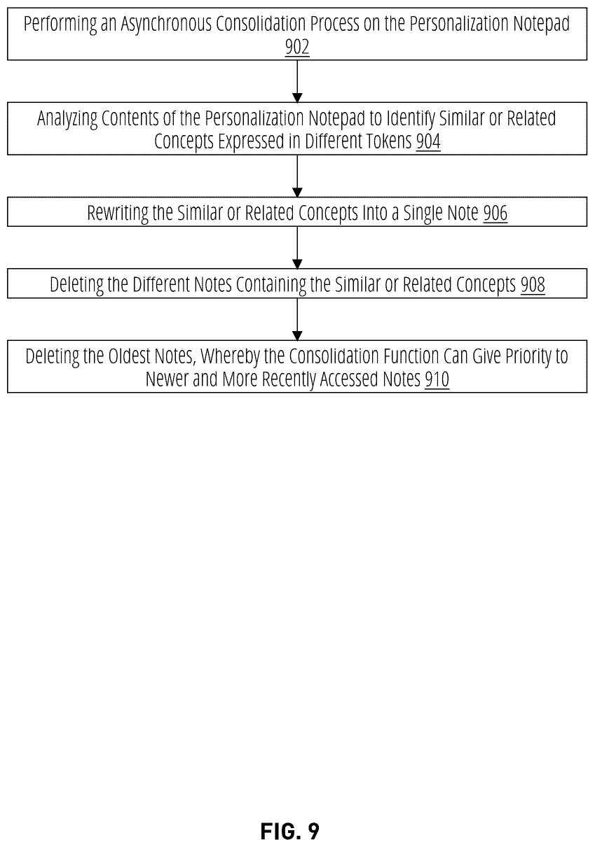

As addressed above, the personalization notepad can be limited to a configured number of notes or a number of tokens. For example, a configured number of notes might be 20, 50, 100, 200, 500, etc. For example, the configured number of tokens can be 100, 200, 500, 1,000, 2,000, 4,000, 10,000, or 100,000 tokens. The personalization notepad is limited in the number of notes or tokens to ensure that the generative response engine 240 can still be responsive and exhibit minimal latency while preparing responses to prompts with the aid of the contents of the personalization notepad. As addressed with respect to FIG. 9, the personalization notepad can occasionally be subjected to a consolidation function, which can be used to prevent the personalization notepad from reaching capacity with similar or related concepts.

The personalization notepad can be persistently stored in a database associated with the user account. When the user account begins a session with the generative response engine 240, the personalization notepad for the user account (or selected identity of the user account) is loaded into a memory associated with an instance of the generative response engine 240 where the data can be quickly referenced by the generative response engine 240 for use in generating responses to prompts.

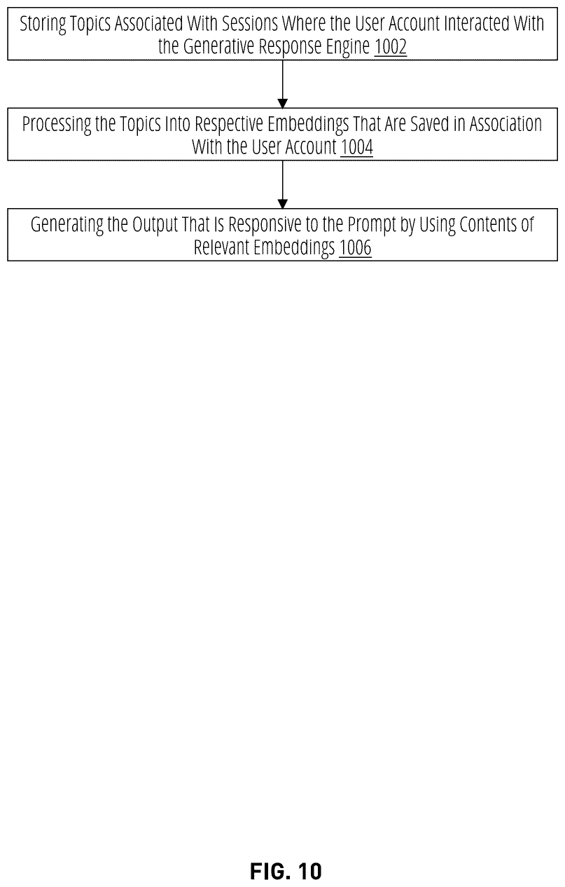

While the personalization notepad is most often addressed throughout this description of the present technology as the data structure for storing the information, persons of ordinary skill in the art will appreciate that other data structures and storage schemes are possible and have their own advantages. For example, while the personalization notepad has the advantage of a simple structure that is human readable, it can also be possible to transform the learned information into embeddings, keys, or weights that might have the advantage of being able to support a greater amount of information. Additionally, it might be possible to store more complex data such as documents, images, or whole conversation threads. The possibility of storing more complex data such as documents, images, or whole conversation threads is addressed further with respect to FIG. 10.

FIG. 5 illustrates an example process for deleting learned information in accordance with some aspects of the present technology. Although the example process depicts a particular sequence of operations, the sequence may be altered without departing from the scope of the present disclosure. For example, some of the operations depicted may be performed in parallel or in a different sequence that does not materially affect the function of the process. In other examples, different components of an example device or system that implements the process may perform functions at substantially the same time or in a specific sequence.

In some embodiments, the user account might desire to have the generative response engine forget information that it has learned. Whether the learned information is no longer relevant or correct, or the user associated with the user account just does not want some information to remain accessible to the generative response engine, the present technology provides for the user account to instruct the generative response engine to forget the learned information.

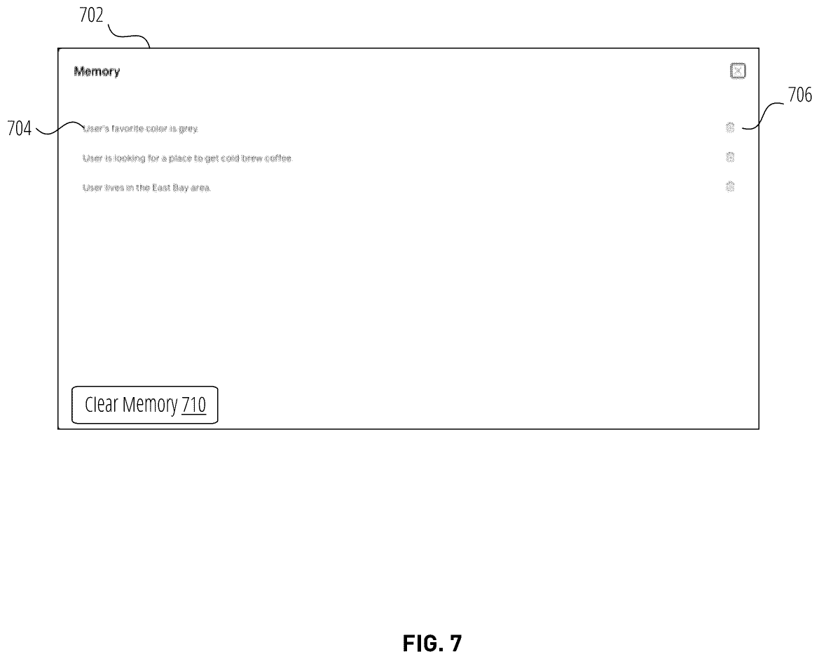

According to some examples, the method includes receiving an input from a user account that requests that the information be removed from the personalization notepad at block 502. For example, the generative response engine 240 illustrated in FIG. 2 may receive the input from a user account that requests that the information be removed from the personalization notepad. Example of such inputs are illustrated in FIG. 6 and FIG. 7.

Just as with the inputs from which the generative response engine learned the information, the input is in the form of a natural language prompt and the generative response engine is trained to recognize that the prompt is requesting to delete data from the personalization notepad.

When the generative response engine 240 recognizes that the input includes a request to delete data from the personalization notepad, the generative response engine can analyze the contents of the personalization notepad to find contents that are relevant to the data identified in the prompt. According to some examples, the method includes identifying, by the generative response engine, one or more notes in the personalization notepad corresponding to the fact, preference, or context at block 504. For example, the generative response engine 240 illustrated in FIG. 2 may identify, by the generative response engine, one or more notes in the personalization notepad corresponding to the fact, preference, or context. FIG. 8A illustrates the presence of information to be deleted in the personalization notepad.

According to some examples, the method includes deleting the one or more notes in response to the input at block 506. For example, the generative response engine 240 illustrated in FIG. 2 may delete the one or more notes in response to the third input. FIG. 8B illustrates the personalization notepad after the information has been deleted.

In some embodiments, the generative response engine can provide a message informing the user account that the information has been deleted, or that the information was not found in the personalized notepad to be removed.

FIG. 6 illustrates example interactions with the generative response engine to request that information be deleted in accordance with some aspects of the present technology. For example, first interaction 602 includes a prompt whereby the user account requests that the generative response engine forget the user's favorite color. In response, the generative response engine can confirm that the note referencing the user's favorite color has been removed. Later, in subsequent interaction 604, the user account can confirm that the knowledge of their favorite color has been removed by providing a prompt regarding their favorite color. Since the note referencing the user's favorite color has been removed, the generative response engine no longer has this knowledge to reference and can reply that it is unaware of the answer to the question.

In some embodiments, a similar interaction can be used to edit information in notes. While not illustrated, a user can provide a prompt to revise information stored in the personalization notepad-perhaps their favorite color changed. The user can provide a prompt that either explicitly requests the generative response engine to revise information recorded in a note like, “My favorite color is no longer blue, it is now red,” or the user can refer to liking red in some prompts and the generative response engine can determine that the users taste may have changed.

FIG. 7 illustrates an example memory management interface 702 in accordance with some aspects of the present technology. Memory management interface 702 provides a graphical user interface to view notes in the personalization notepad such as note 704, and provides options to delete or more notes. For example, delete icon 706 can be selected to delete an individual note, such as note 704, or clear model memory button 710 can be selected to delete all of the notes in the personalization notepad.

FIG. 8A and FIG. 8B illustrate the presence of an information in a personalization notepad that can be deleted in accordance with some aspects of the present technology. In the example illustrated in FIG. 6 wherein the user account has requested that the generative response engine forget the user's favorite color, the generative response engine can search the personalization notepad 802 to locate the information to be deleted 806. And following the instructions given in first interaction 602, the generative response engine can remove the information as indicated by the empty space 808 that indicates that information has been deleted in FIG. 8B.

FIG. 9 illustrates an example process for performing an asynchronous consolidation process on the personalization notepad in accordance with some aspects of the present technology. Although the example process depicts a particular sequence of operations, the sequence may be altered without departing from the scope of the present disclosure. For example, some of the operations depicted may be performed in parallel or in a different sequence that does not materially affect the function of the process. In other examples, different components of an example device or system that implements the process may perform functions at substantially the same time or in a specific sequence.

Over a number of prompts given as inputs, the personalization notepad can become populated with statements of information that might be related. While the generative response engine 240 can determine that the particular information is already in the personalization notepad prior to writing a new note, the generative response engine 240 might record similar or related concepts. For example, one note might identify that the user of the user account has a preferred coffee order at one coffee shop, and another note might record that the user has a different preferred coffee order at another office shop, and still another note might refer to the fact that the user reports being uplifted after visiting good coffee shops. In such instances, the generative response engine 240 can perform an offline, asynchronous consolidation of the personalization notepad where these three notes might be consolidated into a single note. For example, the three notes might be revised to say “The user feels uplifted when visiting good coffee shops such as coffee shop W where the user likes to order X, and coffee shop Y where the user likes to order Z.” Or the generative response engine 240 might determine that one or more notes are not needed any longer and can be deleted.

According to some examples, the method includes performing an asynchronous consolidation process on the personalization notepad at block 902. For example, the generative response engine 240 illustrated in FIG. 2 may perform an asynchronous consolidation process on the personalization notepad. The asynchronous consolidation process can be performed repeatedly at various intervals, or when the personalization notepad approaches or achieves the configured number of notes or tokens. By asynchronous, it is meant that the consolidation process can happen at any time and generally happens in an offline process without any interaction from the user account. For example, the consolidation process might take place at a time when system resource utilization is lower, and therefore there is less competition for computer power, and the cost of running such a process might be lower.

According to some examples, the method includes analyzing the contents of the personalization notepad to identify similar or related concepts expressed in different notesat block 904. For example, the generative response engine 240 illustrated in FIG. 2 may analyze the contents of the personalization notepad to identify similar or related concepts expressed in different notes.

According to some examples, the method includes rewriting similar or related concepts into a single note at block 906. For example, the generative response engine 240 illustrated in FIG. 2 may rewrite similar or related concepts into a single note.

According to some examples, the method, alternatively or in addition, includes deleting the different notes containing similar or related concepts, thereby achieving additional capacity for new notes or tokens in the personalization notepad at block 908. For example, the generative response engine 240 illustrated in FIG. 2 may delete the different notes containing similar or related concepts.

In some embodiments, the notes that are deleted do not necessarily need to include similar or related concepts to be deleted. According to some examples, the method includes deleting the oldest notes, whereby the consolidation function can give priority to newer and more recently accessed note sat block 910. For example, the generative response engine 240 illustrated in FIG. 2 may delete the oldest notes.

In order to account for the possible deletion of the oldest notes by the consolidation function, the present technology can have a mechanism to avoid deleting older but recently accessed notes. For example, the personalization notepad might be reordered or re-dated to keep the most recently utilized notes fresh and avoid deletion.

FIG. 10 illustrates an example process for creating a deep memory in accordance with some aspects of the present technology. Although the example process depicts a particular sequence of operations, the sequence may be altered without departing from the scope of the present disclosure. For example, some of the operations depicted may be performed in parallel or in a different sequence that does not materially affect the function of the process. In other examples, different components of an example device or system that implements the process may perform functions at substantially the same time or in a specific sequence.

While most of the above description has focused on the selective learning of information to be used in personalizing responses generated by the generative response engine 240, in some embodiments, a deeper type of memory can also be desired. While the personalization notepad is utilized to be an efficient and user-readable mechanism to store notes of information relevant to the user account, the deeper memory addressed in FIG. 10 might be associated with a greater amount of data and might not be human readable.

The deep memory can be used to store information about the stored threads associated with a user account. In this mechanism, the generative response engine 240 can have ready access to information about past threads in which the user account has relied upon the generative response engine 240.

According to some examples, the method includes storing topics associated with sessions where the user account interacted with the generative response engine at block 1002. For example, the generative response engine 240 illustrated in FIG. 2 may store topics associated with sessions where the user account interacted with the generative response engine. A plurality of the topics are stored over time.

According to some examples, the method includes processing the topics into respective embeddings that are saved in association with the user account at block 1004. For example, the generative response engine 240 illustrated in FIG. 2 may process the topics into respective embeddings that are saved in association with the user account. The embeddings are saved in a source other than the personalization notepad.

According to some examples, the method includes generating the output that is responsive to the prompt by using contents of relevant embeddings at block 1006. For example, the generative response engine 240 illustrated in FIG. 2 may generate the output that is responsive to the prompt by using the contents of relevant embeddings, whereby the generative response engine has a memory of past sessions that can be used to influence the output. In this way, responses are not only personalized with information relevant to the user account, but the responses may also demonstrate a memory of past threads. Returning to the conceptual example of interacting with an assistant, the deep memory would be akin to the assistant remembering past projects they worked on. Meanwhile, the personalization notepad and the information stored therein would be akin to the assistant remembering that they have worked for the user before and remembering personal information about the user, but perhaps not the projects.

FIG. 11 illustrates an example settings user interface in accordance with some aspects of the present technology. For example, FIG. 11 illustrates an example settings user interface 1102 that can be used to turn on the personalization memory function of the present technology. More specifically the settings user interface 1102 includes toggle 1104 to enable the personalization memory function.

The settings user interface 1102 can also include instructions 1106 explaining how the personalization memory function works and giving examples of prompts in which, the generative response engine will recognize facts to be saved. Additionally, the instructions 1106 can also inform a user that they can request generative response engine 240 to forget some of the knowledge that has been learned.

Additionally, the settings user interface 1102 can include a clear knowledge button 1108. The clear knowledge button 1108 can receive a user input that is effective in clearing the knowledge in the personalization notepad, which removes the personalized knowledge learned by the generative response engine 240 for the user account.

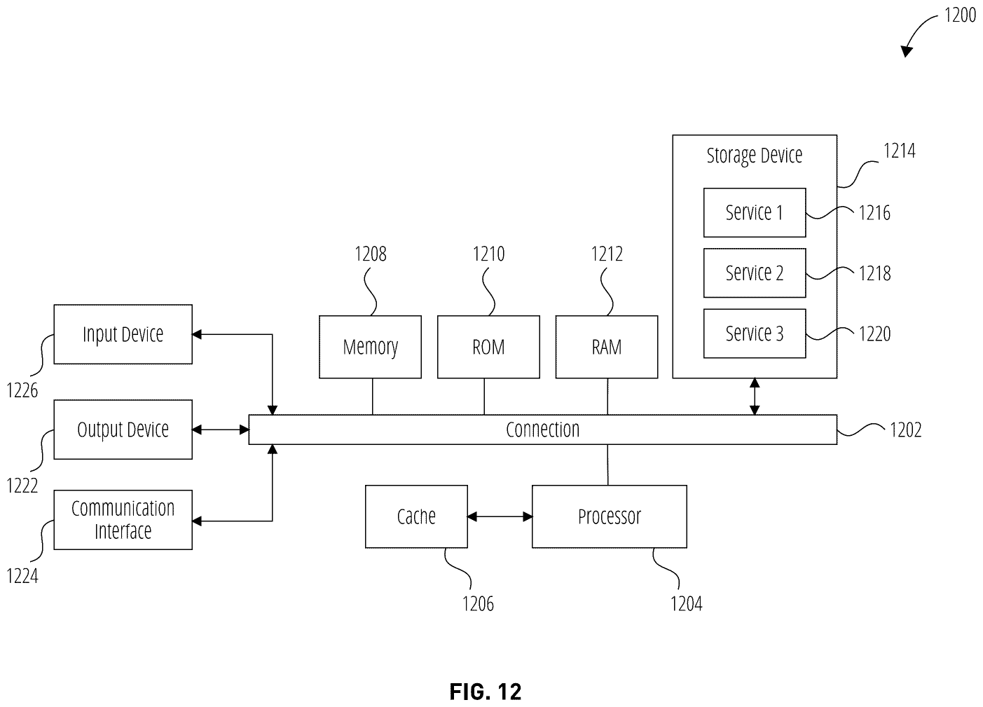

FIG. 12 shows an example of computing system 1200, which can be, for example, any computing device making up any engine illustrated in FIG. 2 or any component thereof in which the components of the system are in communication with each other using connection 1202. Connection 1202 can be a physical connection via a bus, or a direct connection into processor 1204, such as in a chipset architecture. Connection 1202 can also be a virtual connection, networked connection, or logical connection.

In some embodiments, computing system 1200 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1200 includes at least one processing unit (CPU or processor) 1204 and connection 1202 that couples various system components including system memory 1208, such as read-only memory (ROM) 1210 and random access memory (RAM) 1212 to processor 1204. Computing system 1200 can include a cache of high-speed memory 1206 connected directly with, in close proximity to, or integrated as part of processor 1204.

Processor 1204 can include any general purpose processor and a hardware service or software service, such as services 1216, 1218, and 1220 stored in storage device 1214, configured to control processor 1204 as well as a special-purpose processor where software instructions are incorporated into the actual processor design. Processor 1204 may essentially be a completely self-contained computing system, containing multiple cores or processors, a bus, memory controller, cache, etc. A multi-core processor may be symmetric or asymmetric.

To enable user interaction, computing system 1200 includes an input device 1226, which can represent any number of input mechanisms, such as a microphone for speech, a touch-sensitive screen for gesture or graphical input, keyboard, mouse, motion input, speech, etc. Computing system 1200 can also include output device 1222, which can be one or more of a number of output mechanisms known to those of skill in the art. In some instances, multimodal systems can enable a user to provide multiple types of input/output to communicate with computing system 1200. Computing system 1200 can include communication interface 1224, which can generally govern and manage the user input and system output. There is no restriction on operating on any particular hardware arrangement, and therefore the basic features here may easily be substituted for improved hardware or firmware arrangements as they are developed.

Storage device 1214 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1214 can include software services, servers, services, etc., that when the code that defines such software is executed by the processor 1204, it causes the system to perform a function. In some embodiments, a hardware service that performs a particular function can include the software component stored in a computer-readable medium in connection with the necessary hardware components, such as processor 1204, connection 1202, output device 1222, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### Aspects:

The present technology includes computer-readable storage mediums for storing instructions, and systems for executing any one of the methods embodied in the instructions addressed in the aspects of the present technology presented below:
Aspect 1. A method for selectively learning facts for generation of personalized responses, the method comprising: receiving, by a generative response engine, a first input from a user account that includes information associated with a user associated with the user account, wherein the first input can be provided by the user to a computing device through a user interface of the computing device, wherein the first input can be a typed prompt, wherein the first input can be a verbal prompt, wherein the first input can be a series of prompts over time, which when analyzed together identify the information; determining, by the generative response engine, whether the information within the first input should be written to a personalization notepad; writing, by the generative response engine, the information into contents of the personalization notepad; receiving, by the generative response engine, a second input from the user account that includes a prompt to the generative response engine to generate an output that is responsive to the prompt; generating, by the generative response engine, the output that is responsive to the prompt by using the contents of the personalization notepad, wherein the output was influenced by the contents of the personalization notepad including the information within the first input, wherein the evidence that the output was influenced by the contents of the personalization notepad occurs when the output explicitly refers to the contents of the personalization notepad, when the output explicitly refers to the contents of the personalization notepad, when the output is arranged to address information stored within the contents of the personalization notepad, or when the output is limited based on information stored within the contents of the personalization notepad.
Aspect 2. The method of Aspect 1, further comprising: generating an output responsive to the first input informing the user account that the information was written into the personalization notepad.
Aspect 3. The method of any of Aspects 1 to 2, further comprising: determining, by the generative response engine, whether to personalize the output based on the contents of the personalization notepad.
Aspect 4. The method of any of Aspects 1 to 3, wherein the determining whether to personalize the output based on the contents of the personalization notepad includes generating at least a portion of a first candidate response that includes the personalization and at least a portion of a second candidate response that does not include personalization, and evaluates and scores the first candidate response and second candidate response, and selects the preferred candidate response based on the scoring.
Aspect 5. The method of any of Aspects 1 to 4, wherein the generative response engine is trained to perform the determining that the information within the first input should be written to the personalization notepad, wherein the training of the generative response engine utilizes a reinforcement learning process, the reinforcement learning process comprises: generating training prompts, wherein the training prompts can be generated using the generative response engine; identifying, by the generative response engine training information within the training prompt; scoring, the training information to reflect a probability that the training information should be saved; receiving, by a reward function, an external score from a source other than the generative response engine indicating whether the training information should be saved, wherein the external source can be provided by human labelers; and adjusting the generative response engine to produce scoring that is more likely to receive higher external scores.
Aspect 6. The method of any of Aspects 1 to 5, wherein instead of the reinforcement learning process, the generative response engine uses a heuristic to indicate that the information within the first input should be written to the personalization notepad.
Aspect 7. The method of any of Aspects 1 to 6, wherein a first heuristic identifies important personal facts, wherein the important personal facts are not sensitive facts such as health data.
Aspect 8. The method of any of Aspects 1 to 7, wherein a second heuristic identifies contextual facts regarding the user of the user account.
Aspect 9. The method of any of Aspects 1 to 8, further comprising: storing topics associated with sessions where the user account interacted with the generative response engine, wherein a plurality of the topics are stored over time; processing the topics into respective embeddings that are saved in association with the user account; saving the embeddings, wherein the embeddings are saved in a source other than then personalization notepad; generating, by the generative response engine, the output that is responsive to the prompt by using contents of relevant embeddings, whereby the generative response engine has a memory of past sessions that can be used to influence the output.
Aspect 10. The method of any of Aspects 1 to 9, wherein the first input can be a series of prompts over time, which when analyzed together identify the information, wherein the information is not identifiable with enough confidence from a single prompt.
Aspect 11. The method of any of Aspects 1 to 10, wherein the writing the information into contents of the personalization notepad further comprises: including the information as a note within the personalization notepad.
Aspect 12. The method of any of Aspects 1 to 11, further comprising: receiving, by the generative response engine, a third input from a user account that requests that the information within the first input be removed from the personalization notepad, wherein the third input is in the form of a natural language prompt; identifying, by the generative response engine, one or more notes in the personalization notepad corresponding to the information; and deleting the one or more notes in response to the third input.
Aspect 13. The method of any of Aspects 1 to 12, wherein the generative response engine is trained to recognize that the prompt is requesting to delete data from the personalization notepad.
Aspect 14. The method of any of Aspects 1 to 13, wherein the personalization notepad is limited to a configured number of notes, wherein the configured number of notes is 100, 200, 500, 1,000, 2,000, 4,000, 10,000, or 100,000 notes, wherein the configured number of notes is 4,000 notes.
Aspect 15. The method of any of Aspects 1 to 14, further comprising: performing an asynchronous consolidation process on the personalization notepad when the personalization notepad approaches or achieves the configured number of notes.
Aspect 16. The method of any of Aspects 1 to 15, wherein the consolidation function comprises: analyzing contents of the personalization notepad to identify similar or related concepts expressed in different notes; rewriting the similar or related concepts into a single note; and deleting the different notes containing the similar or related concepts, thereby achieving additional capacity for new notes in the personalization notepad.
Aspect 17. The method of any of Aspects 1 to 16, wherein the consolidation function comprises: reordering the notes of the personalization notepad as they accessed; whereby the consolidation function can give priority to newer and more recently accessed notes.
Aspect 18. The method of any of Aspects 1 to 17, wherein the writing the information into contents of the personalization notepad further comprises: creating embeddings for the insights, whereby there does not need to be a limit of the amount of the information that is stored.
Aspect 19. The method of any of Aspects 1 to 18, wherein the personalization notepad is in a user-readable format and can be surfaced for inspection by the user account.
Aspect 20. The method of any of Aspects 1 to 19, further comprising: determining that a track topics option is not enabled whereby the generative response engine does not store the topics associated with sessions where the user account interacted with the generative response engine; wherein the generative response engine does not determine whether the information within the first input should be written to a personalization notepad, whereby when the track topics options is not enabled the information in the prompt is not saved.
Aspect 21. The method of any of Aspects 1 to 20, wherein the user account can create a plurality of identities, wherein the plurality of identities can be associated with a respective personalization notepad, whereby the different identities can be associated with a different set of personalized information.
Aspect 22. The method of any of Aspects 1 to 21, wherein the personalization notepad is persistently stored in a database associated with the user account, wherein the personalization notepad is loaded into a memory associated with an instance of the generative response engine.

What is claimed is:

1. A method for selectively learning facts for generation of personalized responses, the method comprising:
receiving, by a generative response engine, a first input from a user account that includes information associated with a user associated with the user account;
determining, by the generative response engine, whether the information within the first input should be written to a personalization notepad;
writing, by the generative response engine, the information into the personalization notepad;
receiving, by the generative response engine, a second input from the user account that includes a prompt to the generative response engine to generate an output that is responsive to the prompt; and
generating, by the generative response engine, the output that is responsive to the prompt by using contents of the personalization notepad, wherein the output was influenced by the contents of the personalization notepad including the information within the first input.

2. The method of claim 1, further comprising:
determining, by the generative response engine, whether to personalize the output based on the contents of the personalization notepad.

3. The method of claim 1, further comprising:
receiving, by the generative response engine, a third input from the user account that requests that the information within the first input be removed from the personalization notepad;
identifying, by the generative response engine, one or more notes in the personalization notepad corresponding to the information; and
deleting the one or more notes in response to the third input.

4. The method of claim 1, further comprising:
performing an asynchronous consolidation process on the personalization notepad when the personalization notepad approaches or achieves a configured number of notes.

5. The method of claim 4, wherein the asynchronous consolidation process comprises:
analyzing the contents of the personalization notepad to identify similar or related concepts expressed in different notes;
rewriting the similar or related concepts into a single note; and
deleting the different notes containing the similar or related concepts, thereby achieving additional capacity for new notes in the personalization notepad.

6. The method of claim 1, further comprising:
determining that a track topics option is not enabled whereby the generative response engine does not store the topics associated with sessions where the user account interacted with the generative response engine;
wherein the generative response engine does not determine whether the information within the first input should be written to the personalization notepad.

7. The method of claim 1, wherein the user account can create a plurality of identities, wherein the plurality of identities can be associated with a respective personalization notepad, whereby the plurality of identities can be associated with a different information.

8. The method of claim 1, wherein the personalization notepad is persistently stored in a database associated with the user account, wherein the personalization notepad is loaded into a memory associated with an instance of the generative response engine.

9. A computing system comprising:
a processor; and
a memory storing instructions that, when executed by the processor, configure the system to:
receive, by a generative response engine, a first input from a user account that includes information associated with a user associated with the user account;
determine, by the generative response engine, whether the information within the first input should be written to a personalization notepad;
write, by the generative response engine, the information into the personalization notepad;
receive, by the generative response engine, a second input from the user account that includes a prompt to the generative response engine to generate an output that is responsive to the prompt;
generate, by the generative response engine, the output that is responsive to the prompt by using contents of the personalization notepad, wherein the output was influenced by the contents of the personalization notepad including the information within the first input.

10. The computing system of claim 9, wherein the instructions further configure the system to:
determine, by the generative response engine, whether to personalize the output based on the contents of the personalization notepad.

11. The computing system of claim 9, wherein the instructions further configure the system to:
receive, by the generative response engine, a third input from the user account that requests that the information within the first input be removed from the personalization notepad;
identify, by the generative response engine, one or more notes in the personalization notepad corresponding to the information; and
delete the one or more notes in response to the third input.

12. The computing system of claim 9, wherein the instructions further configure the system to:
determine that a track topics option is not enabled whereby the generative response engine does not store the topics associated with sessions where the user account interacted with the generative response engine;
wherein the generative response engine does not determine whether the information within the first input should be written to the personalization notepad.

13. The computing system of claim 9, wherein the user account can create a plurality of identities, wherein the plurality of identities can be associated with a respective personalization notepad, whereby the plurality of identities can be associated with a different information.

14. The computing system of claim 9, wherein the personalization notepad is persistently stored in a database associated with the user account, wherein the personalization notepad is loaded into a memory associated with an instance of the generative response engine.

15. A non-transitory computer-readable storage medium, the computer-readable storage medium including instructions that when executed by at least one processor, cause the at least one processor to:
receive, by a generative response engine, a first input from a user account that includes information associated with a user associated with the user account;
determine, by the generative response engine, whether the information within the first input should be written to a personalization notepad;
write, by the generative response engine, the information into the personalization notepad;
receive, by the generative response engine, a second input from the user account that includes a prompt to the generative response engine to generate an output that is responsive to the prompt;
generate, by the generative response engine, the output that is responsive to the prompt by using contents of the personalization notepad, wherein the output was influenced by the contents of the personalization notepad including the information within the first input.

16. The computer-readable storage medium of claim 15, wherein the instructions further configure the at least one processor to:
determine, by the generative response engine, whether to personalize the output based on the contents of the personalization notepad.

17. The computer-readable storage medium of claim 15, wherein the instructions further configure the at least one processor to:
receive, by the generative response engine, a third input from the user account that requests that the information within the first input be removed from the personalization notepad;
identify, by the generative response engine, one or more notes in the personalization notepad corresponding to the information; and
delete the one or more notes in response to the third input.

18. The computer-readable storage medium of claim 15, wherein the instructions further configure the at least one processor to:
determine that a track topics option is not enabled whereby the generative response engine does not store the topics associated with sessions where the user account interacted with the generative response engine;
wherein the generative response engine does not determine whether the information within the first input should be written to the personalization notepad.

19. The computer-readable storage medium of claim 15, wherein the user account can create a plurality of identities, wherein the plurality of identities can be associated with a respective personalization notepad, whereby the plurality of identities can be associated with a different information.

20. The computer-readable storage medium of claim 15, wherein the personalization notepad is persistently stored in a database associated with the user account, wherein the personalization notepad is loaded into a memory associated with an instance of the generative response engine.
